(19) United States
(12) Patent Application Publication
(10) Pub. No.: US 2009/0271992 A1
(43) Pub. Date: Nov. 5, 2009

(54) Lawn Trimmer Apparatus

(76) Inventor: Edward Carl Holter, Huntsville, AL (US)

Correspondence Address: LANIER FORD SHAVER & PAYNE P.C., P O BOX 2087, HUNTSVILLE, AL, 35804-2087, US

(21) Appl. No.: 12/434,338

(22) Filed: May 1, 2009

Related U.S. Application Data
(60) Provisional application No. 61/049,817, filed on May 2, 2008.

(51) Int. Cl. A01D 34/416

(52) U.S. Cl. 30/276; 30/320; 30/347

(57) ABSTRACT

A lawn trimmer of the present disclosure has a trimmer head with a first opening for receiving string and a second opening for extending the string through so that the string can be used to cut weeds. In addition, the lawn trimmer has a first spool of string mounted to the lawn trimmer, and the string is wound around the spool and has a free end that is inserted into the first opening and out of the second opening. The spool rotates such that when the string breaks during use a user can manually forward the string through the second opening for continued use of the string.

### CROSS-REFERENCE TO RELATED APPLICATIONS

This application claims priority to U.S. Provisional Patent Application Ser. No. 61/049,817 filed on May 2, 2008, entitled “Continuous String Feeding Trimmer,” which is fully incorporated herein by reference.

### BACKGROUND OF THE INVENTION

The present disclosure relates generally to lawn trimmers. More particularly, the present disclosure relates to a lawn trimmer that has continuous string feeding.

Typically, one uses a lawn trimmer for trimming and edging around obstacles on a lawn. For example, one may use a lawn trimmer to level the grass around the base of a tree, fences posts or decking so that the level of the grass around the obstacles is consistent with that of the mowed lawn.

Oftentimes, trimming is accomplished with a gas or electrically powered trimmer that operates a nylon string. As the trimmer is activated, the nylon string spins in a whipping motion and cuts the grass in which it comes into contact.

### SUMMARY OF THE INVENTION

A lawn trimmer in accordance with an embodiment of the present disclosure comprises a spool of string mounted on a shaft and a trimmer head. The trimmer head has a first opening for receiving the string from the spool and a second opening for extending the string through so that the string can be used to cut weeds. The spool rotates such that when the string breaks during use a user can manually forward the string through the second opening for continued use.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a perspective view of an exemplary lawn trimmer in accordance with an embodiment of the present disclosure.

FIG. 2 is a top plan view of a spool of the exemplary lawn trimmer depicted in FIG. 1.

FIG. 3 is a side plan view of the spool of the exemplary lawn trimmer depicted in FIG. 1.

FIG. 4 is a side perspective view of an exemplary shaft and pipe holder in accordance with an embodiment of the present disclosure.

FIG. 5 is a side plan view of another exemplary pipe holder in accordance with an embodiment of the present disclosure.

FIG. 6 is a side perspective view showing the pipe holder of FIG. 5 coupled to a bar holder in accordance with an embodiment of the present disclosure.

FIG. 7 is a side perspective view of the spool of the exemplary lawn trimmer depicted in FIG. 1.

FIG. 8 is a perspective view of an exemplary lawn trimmer in accordance with another embodiment of the present disclosure having two spools mounted on a shaft.

FIG. 9 is a bottom plan view of the trimmer head depicted in FIG. 8.

FIG. 10 is a perspective view of an exemplary lawn trimmer in accordance with another embodiment of the present disclosure having dual spools mounted on a trimmer head of the lawn trimmer.

### DETAILED DESCRIPTION OF THE INVENTION

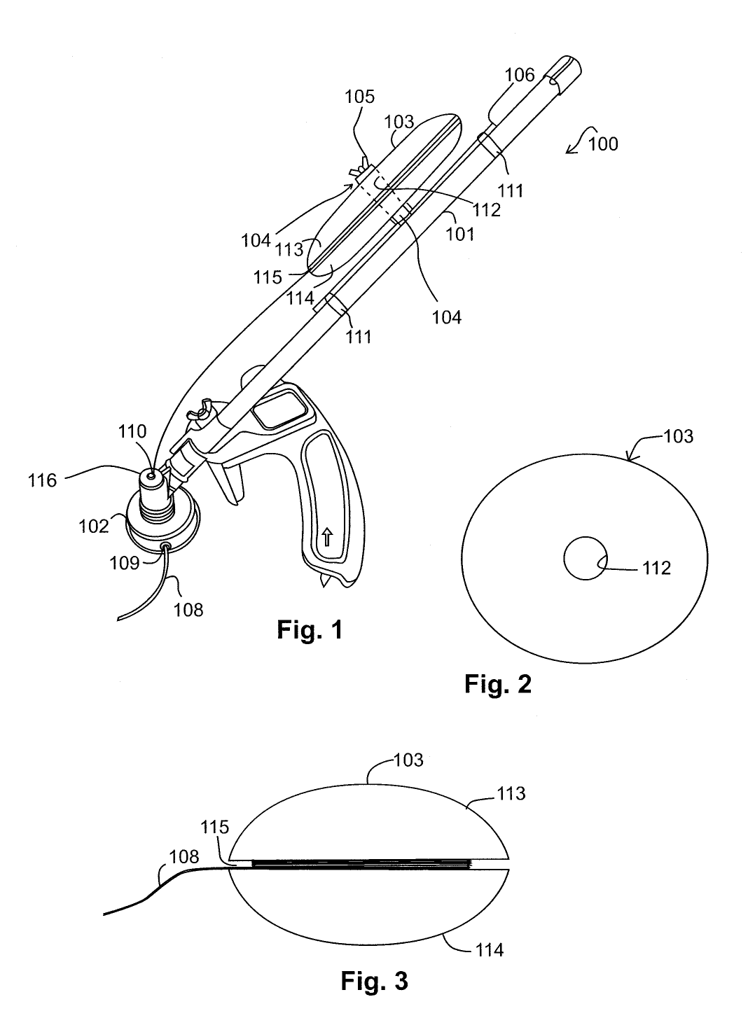

FIG. 1 is a perspective view of an exemplary lawn trimmer 100 in accordance with an embodiment of the present disclosure. The lawn trimmer 100 comprises a shaft 101 that is connected to a trimmer head 102. The trimmer head 102 rotates either through electric or gas powered operation via a motor (not shown).

During operation, a user grasps the shaft 101 of the lawn trimmer 100 and powers on the lawn trimmer 100. The user directs the trimmer head 102 in a direction of weeds and/or grass (not shown) that the user desires to trim. As the lawn trimmer 100 operates, a string 108 that exits an opening 109 in the trimmer head 102 rotates. As the trimmer head 102 rotates, the string trims the weeds and/or grass in the path of the lawn trimmer 100.

In accordance with an embodiment of the present disclosure, the lawn trimmer 100 further comprises a bar holder 106. In one embodiment, the bar holder 106 is composed of aluminum. However, the bar holder 106 may be made of other types of material known in the art or future-developed.

The bar holder 106 attaches to the shaft 101 of the lawn trimmer 100 via one or more rings 111 that are secured to the bar holder 106. In one embodiment, the rings 111 consist of aluminum material. However, the rings 111 may be made of other types of material known in the art or future-developed.

Further, the bar holder 106 is coupled to a pipe holder support 104. In one embodiment, the pipe holder support 104 is composed of aluminum. However, the pipe holder support 104 may be made of other types of material known in the art or future-developed. For example, the pipe holder support 104 may be composed of a plastic material.

The pipe holder support 104 may be coupled to the bar holder 106, for example, via a weld. However, the pipe holder support 104 may be coupled to the bar holder 106 in other ways known in the art or future-developed.

The lawn trimmer 100 further comprises a spool 103 that houses a length of the string 108 wrapped within the spool 103. The spool 103 is rotatably mounted to the shaft 101 via the pipe holder support 104. In this regard, the spool 103 comprises an opening 112. A user aligns the opening 112 of the spool 103 with the pipe holder support 104 and slides the spool 103 over the pipe holder 103.

The spool 103 is mounted on the pipe holder support 104 by inserting the pipe holder support 104 in the opening 112. A wing nut 105 secures the spool 103 to the shaft 101 and the pipe holder support 104.

The spool 103 comprises two sections including a first section 113 and a second section 114. At the intersection of the first section 113 and the second section 114 is a channel 115 that runs the circumference of the spool 103. The channel 115 is opened such that the string 108 can be retrieved from the wound string 108 within the spool 103.

With reference to FIG. 1, the string 108 is retrieved from the spool 103 manually by a user (not shown). The user feeds the string 108 through an opening 110 in a bearing housing 116 that attaches to the trimmer head 102. The opening 110 in the bearing housing 116 provides a path all the way to the opening 109 in the trimmer head 102 through which the string 108 is fed. The user further feeds the string 108 through the opening 109 in the trimmer head 108. Thus, the string 108 is continuously fed from the spool 103, through the bearing housing 116 and out the opening 109.

During operation, the trimmer head 102 rotates, and the string 108 cuts down weeds and/or grass in the path of the lawn trimmer 100. When the string 108 breaks during use, the string 108 is then easily pulled through the opening 109 again to continue use. The string 108 remains available so that the user does not have to rethread the string 108 in order to continue cutting weeds and/or grass.

FIG. 2 depicts a top plan view of the spool 103. As noted herein, the spool 103 comprises the opening 112. The opening 112 goes completely through the entire width of the spool 103.

FIG. 3 is a side plan view of the spool 103. FIG. 3 further illustrates the channel 115 that runs the circumference of the spool 103. The channel enables the string 108 to be retrieved from the wound string 108 within the spool 108.

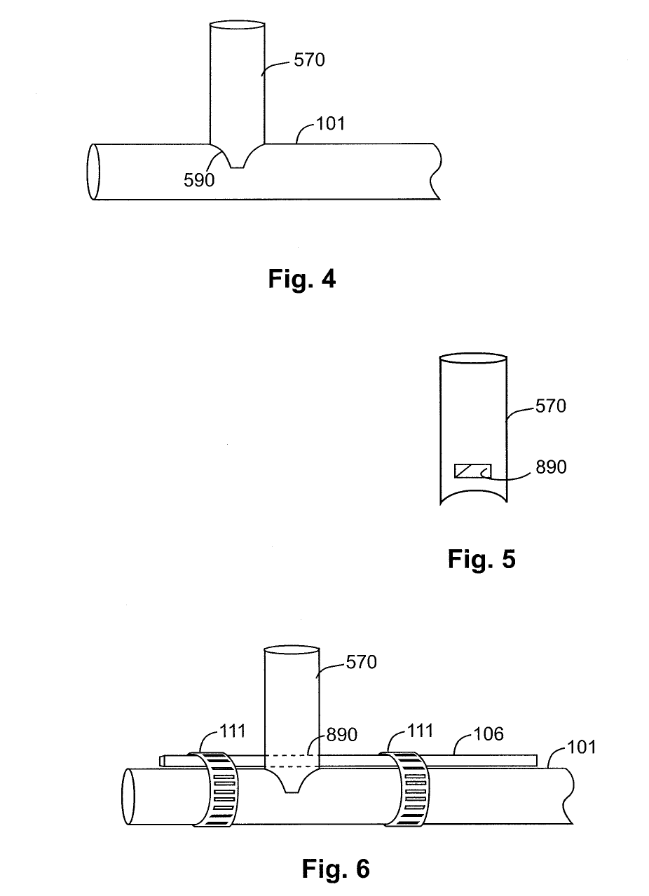

With respect to FIG. 4, the pipe holder 104 may not necessarily be coupled to the bar holder 106. In such an embodiment, the bar holder 106 may not be desirable. In this regard, the end 590 of the pipe holder 104 may be machined to exhibit a radius of curvature such that the end 590 fits snugly against the shaft 101 as shown. In such an embodiment, the end 590 may be welded, for example, to the shaft 101.

In another embodiment, as illustrated in FIG. 5, a pipe holder 570 may comprise an opening 890 that extends through the width of the pipe holder 570. In such an embodiment, the opening 890 may be substantially rectangular, which is described further with reference to FIG. 6. Further, the end 571 of the pipe holder 570 may curved.

FIG. 6 depicts the pipe holder 570 such that the curved end 571 sits snugly to the shaft 101. In such an embodiment, the bar holder 106 fits all the way through the opening 890 of the pipe holder 570. On each side of the pipe holder 570, the bar holder 106 is coupled to the shaft 101 with one or more of the rings 111.

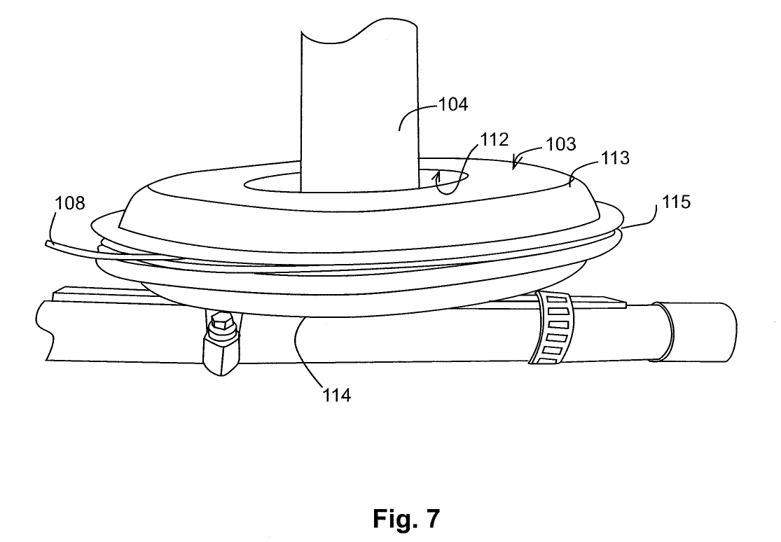

FIG. 7 depicts a perspective view of the spool 103. The spool 103 comprises the sections 113 and 114 that connect together to form the channel 115. The string 108 is wound about the wall formed by the opening 112 and a portion of the string 108 protrudes for pulling the string 108 from the spool 103. The pipe holder support 104 receives the spool 103 via the opening 112. The spool 103 can be secured on the pipe holder support 104 via the nut 105 (FIG. 1).

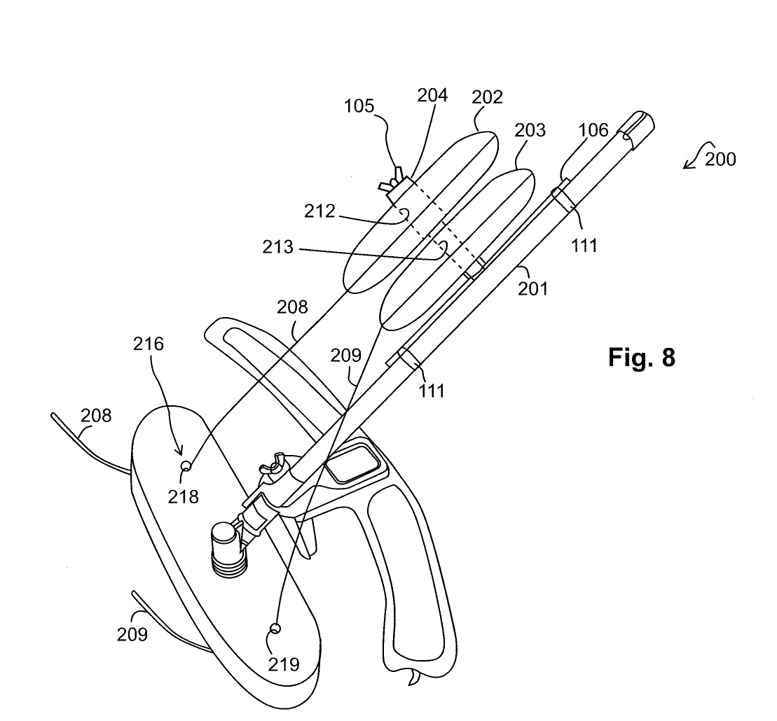

FIG. 8 depicts a lawn trimmer 200 in accordance with another embodiment of the present disclosure. The lawn trimmer 200 works similarly to the lawn trimmer 100 depicted in FIG. 1, however, the lawn trimmer 200 comprises two spools 202 and 203. Each of the spools 202 and 203 are wound with string 208 and 209, respectively.

The spools 202 and 203 are rotatably mounted to a single shaft 201 via a pipe holder support 204. Note that the pipe holder 204 is longer than the pipe holder support 104 (FIG. 1) to accommodate the two spools 202 and 203. The spools 202 and 203 have openings 212 and 213, respectively, and the spools 202 and 203 are mounted on the shaft 201 by inserting the pipe holder 204 into the openings 212 and 213 and securing them with a wing nut 105.

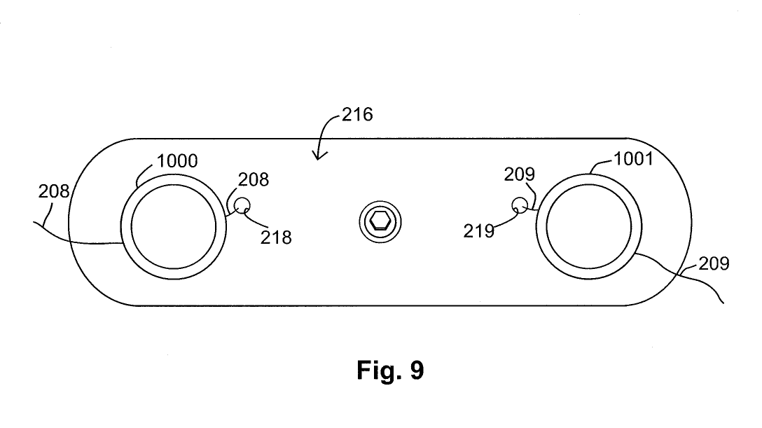

A user (not shown) pulls the strings 208 and 209 from the spools 202 and 203, respectively. The user inserts the ends of the strings 208 and 209 through the openings 218 and 219 on an encasing 216 until the strings 208 and 209 are at a length from trimmer heads (shown in FIG. 9) to cut weeds and/or grass (not shown).

If during operation, one of the strings 208 and 209 breaks, the user can manually feed additional string 208 and 209 to continue use. The user can grab the string 208 and 209 and pull, and the spools 202 and 203 rotate about the pipe holder support 204 to provide additional string 208 and 209 when a break occurs.

Note that the pipe holder support 204 is mounted to the shaft 201 in a similar fashion as that for the lawn trimmer 100 (FIG. 1). Notably, the pipe holder support 204 is mounted to the bar holder 106, and the bar holder 106 is mounted to the shaft 201 via rings 111. However, the pipe holder 204 may be mounted in the way described above with reference to FIG. 4.

FIG. 9 is a bottom plan view of the encasing 216 of the lawn trimmer 200 depicted in FIG. 8. The encasing 216 houses two trimmer heads 1000 and 1001. Each of the trimmer heads 1000 and 1001 receives a string 208 and 209, respectively, through the openings 218 and 219, respectively. During operation, each of the trimmer heads 1000 and 1001 rotates independent of the other to trim and/or edge weeds and/or grass (not shown). If one of the strings 208 or 209 breaks, the user (not shown) can pull the string 208 or 209 through the openings 218 or 219 from the spools 202 or 203, respectively, to continue operation.

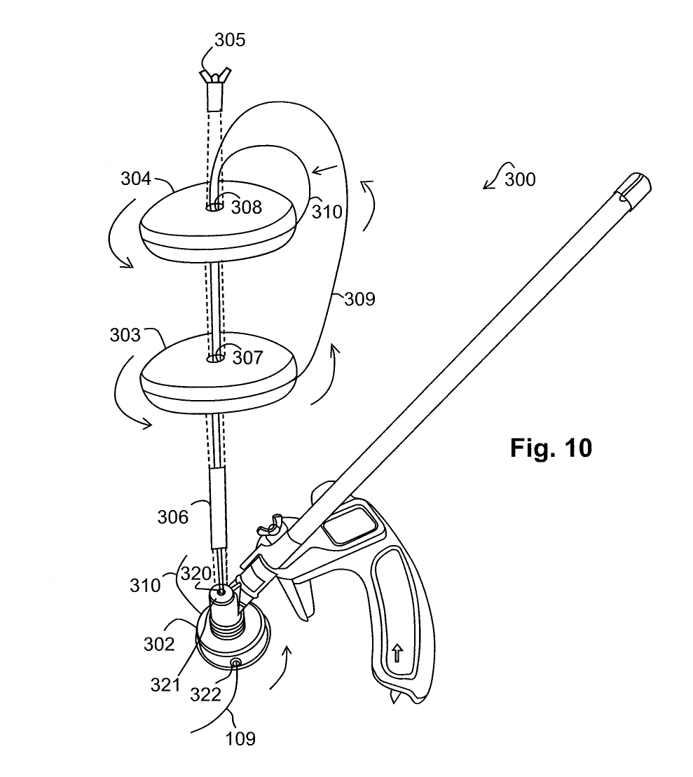

FIG. 10 is an exploded perspective view of a lawn trimmer 300 in accordance with another embodiment of the present disclosure. The lawn trimmer 300 works similarly to lawn trimmer 100 (FIG. 1) and lawn trimmer 200 (FIG. 2). However, in the lawn trimmer 300 one or more spools 303 and 304 are mounted on top if a trimmer head 302.

The spools 303 and 304 are mounted to a pipe holder support 306. The pipe holder support 306 is mounted to a bearing 321. The bearing 321 has an opening 320.

In such an embodiment, once assembled a user (not shown) pulls strings 309 and 310 from their respective spools 303 and 304. The user then inserts the strings through the openings 307 and 308 of the spools 303 and 304, respectively. The strings 309 and 310 run through the pipe holder support 306, through opening 320 and out a first opening 322 in the trimmer head 302 and a second opening (not shown).

Note that in such an embodiment, there are two openings, the opening 322 through which the string 309 exits the trimmer head 302 and another opening (not shown) on the opposing side of the trimmer head 302 through which the string 310 exits the trimmer head 302. The opening that is not shown through which string 310 exist the trimmer head 302 is substantially similar to the opening 322. Thus, for brevity and clarity, only opening 322 is shown.

During operation, the trimmer head 302 rotates. As the trimmer head 302 rotates, strings 309 and 310 rotate. As the strings 309 and 310 rotate, they edge and trim weeds and/or grass.

Note that each spool 303 and 304 corresponds to a separate string 309 and 310, respectively. Thus, if string 309 breaks, the user (not shown) pulls the string 309 which rotates spool 303 thereby obtaining additional string from the spool 303. On the other hand, if string 310 breaks, the user pulls the string 310 which rotates spool 304 thereby obtaining additional string from the spool 304.

Now, therefore, the following is claimed:

1. A lawn trimmer, comprising:
a trimmer head having a first opening for receiving string and a second opening for extending the string through so that the string can be used to cut weeds; and
a first spool of string mounted to the lawn trimmer, the string wound around the spool and having a free end for inserting into the first opening and out of the second opening, the spool rotatable such that when the string breaks during use a user can manually forward the string through the second opening for continued use of the string.

2. The lawn trimmer of claim 1, wherein the first spool of string is mounted to a shaft.

3. The lawn trimmer of claim 2, further comprising a bar holder coupled to the shaft.

4. The lawn trimmer of claim 3, wherein the bar holder is coupled to the shaft via one or more rings.

5. The lawn trimmer of claim 3, further comprising a substantially cylindrical tube mounted to the bar holder.

6. The lawn trimmer of claim 5, wherein the first spool comprises a spool opening for coupling to the cylindrical tube thereby retaining the spool relative to the bar holder.

7. The lawn trimmer of claim 1, wherein the first spool comprises a first half and a second half coupled together to form a channel around which the string is wound.

8. The lawn trimmer of claim 1, further comprising a second spool.

9. The lawn trimmer of claim 8, further comprising a substantially cylindrical tube attached to a bar holder and mounted on a shaft.

10. The lawn trimmer of claim 9, wherein the first spool and the second spool comprise a first spool opening and a second spool opening, respectively.

11. The lawn trimmer of claim 10, wherein the first spool opening and the second spool opening couple to the substantially cylindrical tube thereby retaining the first and second spools relative to the bar holder.

12. The law trimmer of claim 11, further comprising a wing nut that attaches to the substantially cylindrical tube to secure the first and second spools on the substantially cylindrical tube.

13. A lawn trimmer, comprising:
a trimmer head having a first opening for receiving string and a second opening for extending the string through so that the string can be used to cut weeds; and
at least one spool for housing the string, the at least one spool mounted to the trimmer for supplying string to the first opening and out the second opening.

14. The lawn trimmer of claim 13, further comprising a hollow pipe coupled to the trimmer head over the first opening.

15. The lawn trimmer of claim 14, wherein the at least one spool has an opening.

16. The lawn trimmer of claim 15, wherein the hollow pipe couples to the opening of the spool thereby retaining the spool relative to the trimmer head.

17. The lawn trimmer of claim 15, wherein the string extends through the hollow pipe, into the first opening and out through the second opening.

18. The lawn trimmer of claim 13, further comprising a first spool and a second spool, the first spool and the second spool comprising a first spool opening and a second spool opening.

19. The lawn trimmer of claim 18, wherein a pipe extending from the trimmer head couples to the first spool opening and the second spool opening thereby retaining the first and second spools relative to the trimmer head.

20. The lawn trimmer of claim 19, further comprising a third opening for receiving string from the second spool and a fourth opening for extending the string from the second spool through so that the string can be used to cut weeds.
